(19) United States
(12) Patent Application Publication
(10) Pub. No.: US 2025/0129263 A1
(43) Pub. Date: Apr. 24, 2025

(54) CURABLE COMPOSITION AND 3D-PRINTED OBJECT FORMED THEREFROM AND PROCESS FOR FORMING THE SAME

(71) Applicant: BASF SE, Ludwigshafen am Rhein (DE)

(72) Inventors: Wei Zheng FAN, Shanghai (CN); Zhi Zhong CAI, Shanghai (CN); Li CHEN, Shanghai (CN); Chong Xi WANG, Shanghai (CN)

(21) Appl. No.: 18/685,541

(22) PCT Filed: Aug. 3, 2022
(86) PCT No.: PCT/EP2022/071857

§ 371 Date: Feb. 22, 2024

(30) Foreign Application Priority Data
Aug. 26, 2021 (WO) PCT/CN2021/114750

(51) Int. Cl. C09D 175/14; B29C 64/124; B29K 75/00; B29K 96/04; B29K 105/00; B33Y 10/00; B33Y 70/00; B33Y 80/00; C09D 175/12

(52) U.S. Cl. CPC C09D 175/14; B33Y 70/00; C09D 175/12; B29C 64/124; B29K 2075/00; B29K 2096/04; B29K 2105/0002; B33Y 10/00; B33Y 80/00

(57) ABSTRACT

The present invention relates to a curable composition, which comprises: (A) at least one unreactive blocked diisocyanate; (B) at least one unreactive blocked diamine; (C) at least one reactive component; and (D) at least one photo-initiator, wherein component (B) is formed by blocking diamine with a ligand; to a process of forming a 3D-printed object from the same and a 3D-printed object prepared therefrom. The curable composition exhibits excellent long-term stability, while the 3D-printed object obtained therefrom maintains good mechanical properties

### TECHNICAL FIELD

The present invention relates to a composition for three-dimensional (hereinafter referred to as “3D”) printing. In particular, the present invention relates to a dual-curable composition for 3D-printing. The present invention further relates to a process of forming a 3D-printed object by using the composition, and a 3D-printed object formed therefrom.

### BACKGROUND

3D-printing technologies, e.g. stereolithography (SLA), digital light processing (DLP) and photopolymer jetting (PPJ), have been used in many applications, e.g. rapid prototyping, manufacturing of hearing aids, and manufacturing of dental parts. Photopolymers can be 3D-printed by technologies such as SLA, DLP and PPJ through photo-initiated polymerization triggered by UV or visible light.

To obtain 3D-printed object, acrylate or epoxy is one member of the main class of radiation-curable materials conventionally used. The photo-initiated polymerization of acylates or epoxies occurs during a 3D-printing process for a 3D-printed object. However, polyacrylate or polyepoxides cannot achieve good mechanical properties, such as good elasticity or toughness.

Introducing urethane or urea bonds is a good way to improve the properties of printed objects. In general, urethane/urea bonds will be introduced via using urethane/urea-based acrylates or epoxies. However, the obtained oligomers normally have high viscosity that needs to be reduced by introducing reactive diluents. Incorporating reactive diluents sacrifices the properties of printed objects due to dilution of the urethane/urea bonds in the final network.

Recently, it is reported to introduce polyurethane/urea via dual-cure mechanism, which builds up polyacrylate network during printing process and builds up polyurethane/urea network under post-treatment. However, these dual-cure resins exhibit poor resin stability and need to be stored as two-component system.

Therefore, there is a strong need to provide dual-curable compositions with long-term stability, which enable successful 3D-printing process by technologies such as SLA, DLP or PPJ, meanwhile bring good mechanical properties.

### SUMMARY OF THE INVENTION

It is an object of the invention to provide a curable composition comprising at least one unreactive blocked diisocyanate and at least one unreactive blocked diamine, wherein the unreactive blocked diamine is formed by blocking diamine with a ligand. The

curable composition is curable via dual-cure mechanism, and exhibits excellent long-term stability, while the 3D-printed object obtained therefrom maintains good mechanical properties.

Another object of the present invention is to provide a 3D-printed object formed from the curable composition of the present invention.

A further object of the present invention is to provide a process of forming 3D-printed object by using the curable composition of the present invention.

It has been surprisingly found that the above objects can be achieved by following embodiments:

1. A curable composition, which comprises:
(A) at least one unreactive blocked diisocyanate;
(B) at least one unreactive blocked diamine;
(C) at least one reactive component; and
(D) at least one photo-initiator,
   wherein component (B) is formed by blocking diamine with a ligand.

2. The curable composition according to embodiment 1, the diisocyanate for forming component (A) comprises diisocyanate monomers and/or diisocyanate prepolymers, wherein

the diisocyanate monomers are selected from the group consisting of aliphatic diisocyanate, araliphatic diisocyanate, cycloaliphatic diisocyanate, aromatic diisocyanate, and the combination thereof, preferably the diisocyanate for forming component (A) is selected from diisocyanates having 3 to 40 carbon atoms, more preferably the diisocyanate for forming component (A) is selected from the group consisting of cyclohexyl-1,4-diisocyanate, diphenylmethane-4,4′-diisocyanate, toluene diisocyanates, hexamethylene diisocyanate, isophorone diisocyanate;
the diisocyanate prepolymers are prepolymers having two free isocyanate groups, obtained from the reaction of diisocyanate monomers with polyester diols, polyether diols, polycarbonate diols, or diamines, more preferably obtained from the reaction of diisocyanate monomers with polyether diols. the preferable diisocyanate prepolymers having two free isocyanate groups are polyurethane prepolymers having two free isocyanate groups, polyurea prepolymers having two free isocyanate groups, and the combination thereof.

3. The curable composition according to embodiment 1 or 2, wherein the diamine for forming component (B) is selected from the group consisting of aliphatic diamine, cycloaliphatic diamine, aromatic diamine, aliphatic-aromatic diamine, cycloaliphatic-aromatic diamine, aliphatic-cycloaliphatic diamine and the combination thereof;

preferably the diamine for forming component (B) is selected from the group consisting of diamines of the formula NH₂-R¹-NH₂, NHR²-R¹-NHR³, NH₂-P-NH₂ and NHR²-P-NHR³, in which
the radical R¹ is linear or else cyclic divalent hydrocarbyl, aliphatic or else aromatic divalent hydrocarbyl, having 3 to 40 carbon atoms, more preferably having 3 to 30 carbon atoms,
P is aliphatic, cycloaliphatic, aromatic, aliphatic-aromatic, cycloaliphatic-aromatic, aliphatic-cycloaliphatic polyester moiety, polyether moiety, polyurethane moiety, or polyurea moiety, or the combination thereof, preferably P is aliphatic, cycloaliphatic, aromatic, aliphatic-aromatic, cycloaliphatic-aromatic, aliphatic-cycloaliphatic polyester moiety, polyether moiety, or polyurethane moiety, more preferably P is aliphatic polyester moiety, polyether moiety, or polyurethane moiety,

R² and R³, independently from each other, are C₁-C₁₀-alkyl, C₆-C₂₀-aryl, C₇-C₂₀-arylalkyl, C₇-C₂₀-alkylaryl or C₇-C₂₀-cycloalkyl; and, more preferably the diamine for forming component (B) is selected from the group consisting of butylenediamine, pentanediamine, hexamethylenediamine, tolylenediamine, xylylenediamine, diaminodiphenylmethane, diaminodicyclohexylmethane, phenylenediamine, cyclohexylenediamine, isophoronediamine, bis (aminomethyl) cyclohexane, diamines of the NH₂-R¹-NH₂, NHR²-R¹-NHR³, NH₂-P-NH₂, and NHR²-P-NHR³, wherein R¹ is C₃-C₁₀-alkylene, P is aliphatic polyester moiety, polyether moiety, or polyurethane moiety, and R² and R³independently from each other are methyl, ethyl, propyl, and butyl, and the combination thereof.

4. The curable composition according to any one of embodiments 1 to 3, wherein reactive component (C) contains at least one radiation-curable functional group, preferably the radiation-curable functional group is selected from the group consisting of an ethylenically unsaturated functional group, an epoxy group, or the mixture thereof, more preferably the radiation-curable functional group is an ethylenically unsaturated functional group, preferably reactive component (C) is a (meth)acrylate having 1 to 12, preferably 1 to 10, more preferably 1 to 8 ethylenically unsaturated functional groups.

5. The curable composition according to any one of embodiments 1 to 4, wherein the photo-initiator is a free radical photo-initiator and/or an ionic photo-initiator, preferably a free radical photo-initiator.

6. The curable composition according to any one of embodiments 1 to 5, wherein the amount of component (A) is in the range from 0.1 to 85% by weight, preferably from 0.5 to 70% by weight, more preferably from 1 to 60% by weight, based on the total weight of the composition.

7. The curable composition according to any one of embodiments 1 to 6, wherein the amount of component (B) is in the range from 0.1 to 85% by weight, preferably from 0.5 to 70% by weight, more preferably from 1 to 60% by weight, based on the total weight of the composition.

8. The curable composition according to any one of embodiments 1 to 7, wherein the amount of component (C) is in the range from 10 to 99% by weight, preferably from 30 to 90% by weight, more preferably from 35 to 90% by weight, based on the total weight of the composition.

9. The curable composition according to any one of embodiments 1 to 8, wherein the amount of component (D) is in the range from 0.1 to 10% by weight, preferably from 0.1 to 8% by weight, more preferably from 0.1 to 5% by weight, based on the total weight of the composition.

10. The curable composition according to any one of embodiments 1 to 9, wherein after deblocking component (A) and component (B), the molar ratio of isocyanate group to amino group in the composition is in a range from 1.3 to 0.7, preferably in a range from 1.2 to 0.8, more preferably in a range from 1.1 to 0.9.

11. The curable composition according to any one of embodiments 1 to 10, wherein the ligand is selected from monodentate ligands, such as F⁻, Cl⁻, Br⁻, I⁻, CN⁻, SCN⁻, NCS⁻, OH⁻, nitro, NO₂⁻, CH₃COO⁻, SO₃²⁻; S₂O₃²⁻, and carbonyl; bidentate ligands, such as ethylenediamine, 1,10-phenanthroline (phen), 8-Hydroxyquinoline, H₂N-CH₂-COO⁻, and C₂O₄²⁻, polydentate ligands, such as diethylenetriamine (DEN), nitrilotriacetic acid (NTA), and ethylenediaminetetraacetic acid, preferably the ligand is selected from monodentate ligands F⁻, Cl⁻, Br⁻, I⁻, CN⁻, SCN⁻, NCS⁻, OH,⁻nitro, NO₂⁻, CH₃COO⁻, SO₃²⁻, S₂O₃²⁻, and carbonyl.

12. The curable composition according to any one of embodiments 1 to 11, which further comprises component (E) an auxiliary agent, such as surfactants, unreactive diluents, pigments, fillers, dyes, and plasticizers, preferably in an amount in the range from 0 to 60% by weight, preferably from 0 to 50% by weight, more preferably from 0 to 40% by weight, based on the total weight of the composition.

13. The curable composition according to any one of embodiments 1 to 12, wherein the change of the viscosity of the curable composition measured according to DIN EN ISO 3219 at 23° C. from being freshly prepared to being stored for 7 days is less than 10%, preferably less than 8%.

14. The curable composition according to any one of embodiments 1 to 13, wherein the change of the viscosity of the curable composition measured according to DIN EN ISO 3219 at 23° C. from being freshly prepared to being stored for 14 days is less than 10%, preferably less than 6%.

15. A process of forming a 3D-printed object, comprising using the curable composition according to any one of embodiments 1 to 14.

16. The process according to embodiment 15, wherein the process comprises the steps of:
(i) applying the composition in form of a layer, and curing the applied composition layer by layer by radiation to form an intermediate 3D-printed object;
(ii) curing the whole intermediate 3D-printed object by radiation to form a cured 3D-printed object; and
(iii) thermally curing the whole cured 3D-printed object to form a final 3D-printed object.

17. The process according to embodiment 16, wherein stereolithography, photopolymer jetting, digital light processing, or LCD technology is used in step (i) to form the intermediate 3D-printed object.

18. The process according to embodiment 16 or 17, wherein the radiation is UV radiation.

19. A 3D-printed object formed from the composition according to any one of embodiments 1 to 14 or obtained by the process according to any one of embodiments to 18.

20. The 3D-printed object according to embodiment 19, wherein the 3D-printed object comprises sole, outerwear, cloth, footwear, toy, mat, tire, hose, gloves, seals, medical appliances such as hearing aids, and dental parts.

The curable composition of the present invention is curable via dual-cure mechanism and exhibits excellent long-term stability, while the 3D-printed object obtained therefrom maintains good mechanical properties.

### DESCRIPTION OF THE DRAWINGS

FIG. 1 shows a schematic diagram illustrating Area Under Unloading Curve and Area Under Loading Curve in Cyclic Tensile Test used in the examples.

FIG. 2 shows the morphology of the 3D-printed object of example A1.

### DETAILED DESCRIPTION OF THE INVENTION

Unless defined otherwise, all technical and scientific terms used herein have the meaning commonly understood by a person skilled in the art to which the invention belongs. As used herein, the following terms have the meanings ascribed to them below, unless specified otherwise.

The articles “a”, “an” and “the” mean one or more of the species designated by the term following said article.

In the context of the present disclosure, any specific values mentioned for a feature (comprising the specific values mentioned in a range as the end point) can be recombined to form a new range.

Further embodiments of the present invention are discernible from the claims, the description, the examples, and the drawings. It will be understood that the aforementioned and hereinbelow still to be elucidated features of the subject matter of the present invention are utilizable not only in the particular combination indicated, but also in other combinations without leaving the realm of the present invention.

### Curable composition

One aspect of the present invention relates to a curable composition, which comprises:
(A) at least one unreactive blocked diisocyanate;
(B) at least one unreactive blocked diamine
(C) at least one reactive component; and
(D) at least one photo-initiator,
   wherein component (B) is formed by blocking diamine with a ligand.

### Diisocyanate (A)

The curable composition of the present invention comprises at least one unreactive blocked diisocyanate as component (A).

Diisocyanate suitable for forming component (A) of the present invention may be selected from any organic compound having two isocyanate groups per molecule, including not only those in which the isocyanate groups are attached to a hydrocarbon radical but also those in which the isocyanate groups are attached to a radical including a heteroatom such as oxygen or nitrogen, for example as part of ester groups, ether groups, and the like, as well as combinations of these.

Diisocyanate suitable for forming component (A) of the present invention may be an aliphatic diisocyanate, or araliphatic diisocyanate, or cycloaliphatic diisocyanate, or aromatic diisocyanate, comprising diisocyanate monomers and/or diisocyanate prepolymers.

For example, the diisocyanate may contain from 3 to 40 carbon atoms, and in various embodiments, the diisocyanate may contain from 4 to 20, from 5 to 24, or from 6 to 18, carbon atoms. In certain embodiments, the diisocyanate is a symmetrical aliphatic or cycloaliphatic diisocyanate.

Nonlimiting examples of suitable diisocyanate monomers include aliphatic diisocyanates such as trimethylene-1,3-diisocyanate, tetramethylene-1,4-diisocyanate, hexamethylene diisocyanate (1,6-diisocyanatohexane), octamethylene diisocyanate, decamethylene diisocyanate, dodecamethylene diisocyanate, tetradecamethylene diisocyanate, trimethylhexane diisocyanate or tetramethylhexane diisocyanate; cycloaliphatic diisocyanates such as 1,4-, 1,3- or 1,2-diisocyanatocyclohexane, 4,4′- or 2,4′-di(isocyanatocyclohexyl)-methane, 1-isocyanato-3,3,5-trimethyl-5-(isocyanatomethyl) cyclohexane (isophorone diisocyanate), 1,3- or 1,4-bis(isocyanatomethyl) cyclohexane or 2,4- or 2,6-diisocyanato-1-methylcyclohexane; and also aromatic diisocyanates such as 2,4- or 2,6-tolylene diisocyanate and isomer mixtures thereof, m-or p-xylylene diisocyanate, 2,4′- or 4,4′-diisocyanatodiphenylmethane and isomer mixtures thereof, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate; and the mixtures thereof.

Preferably, the diisocyanate monomers may be selected from the group consisting of cyclohexyl-1,4-diisocyanate, diphenylmethane-4,4′-diisocyanate, toluene diisocyanates, hexamethylene diisocyanate, isophorone diisocyanate, and the mixtures thereof.

In the present invention, the diisocyanate suitable for forming component (A) of the present invention also comprises diisocyanate prepolymer. The term “diisocyanate prepolymer” means a prepolymer having two free isocyanate groups.

Diisocyanate prepolymers suitable for the present invention may be obtainable by reacting the NCO functional groups of the isocyanate component with an active hydrogen-containing material, for example at a temperature of from 30 to 200° C., preferably at about 50-180° C., to give an isocyanate-terminated prepolymer having two free isocyanate groups. For example, diisocyanate prepolymers suitable for the present invention comprise a diisocyanate oligomer produced by the reaction of at least one diisocyanate monomer with at least one diol or diamine. The diisocyanate monomer may be selected from those listed above.

In some embodiments, the active hydrogen-containing material may be selected from a group consisting of polyester diols, polyether diols, polycarbonate diols, and diamines. In some embodiments, the active hydrogen-containing material is polyether diols. In some embodiments, the active hydrogen-containing material is polyester diols.

In some embodiments, the active hydrogen-containing material is a mixture of one or more polyester diols and one or more polyether diols.

For example, diisocyanate prepolymer suitable for the present invention may be diisocyanate prepolymer based on polyester diols, diisocyanate prepolymer based on polyether diols, diisocyanate prepolymer based on polycarbonate diols, and diisocyanate prepolymer based on diamines.

Polyester diols preferably comprise alternating acid and alcohol units. As acid components, preference is given to using succinic acid, adipic acid, phthalic anhydride, phthalic acid or mixtures of the acids and/or anhydrides mentioned. Alcohol components used may be ethanediol, 1,2-propanediol, 1,3-propanediol, 1-4-butanediol, 1,5-pentanediol, 1,6-hexanediol, diethylene glycol, dipropylene glycol or mixtures of the alcohols mentioned.

As polyether diols, preference is given to polyether diols which are made up of repeating ethylene oxide and propylene oxide units, preferably with a proportion of propylene oxide units of from 35 to 100% by mole, particularly preferably with a proportion of propylene oxide units of from 50 to 100% by mole. These can be random copolymers, gradated copolymers, alternating copolymers or block copolymers of ethylene oxide and propylene oxide. Suitable polyether diols may also be polytetrahydrofuran.

Suitable polycarbonate diols may include products obtained by reacting diols such as 1,3-propanediol, 1,4-butanediol, 1,6-hexanediol, diethylene glycol or tetraethylene glycol with diaryl carbonates, e.g. diphenyl carbonate, or with phosgene.

Suitable diamines are such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexyl-methane, 1,4-diaminocyclohexane, aminoethylethanolamine, hydrazine, hydrazine hydrate.

Polyurethane prepolymers having two free isocyanate groups, polyurea prepolymers having two free isocyanate groups, and the combination thereof, may also be used as the diisocyanate suitable for the present invention.

In the present invention, component (A) is formed by blocking diisocyanates with blocking agents. The term “unreactive blocked diisocyanate” means the blocked diisocyanate will not be cured under radiation-curing conditions because there is no radiation curable groups in the structures.

The unreactive blocked diisocyanate will release two free isocyanate groups per molecule after thermal deblocking. Usually the deblocking means exposure to elevated temperatures (known as deblocking temperature), such as 60 to 200° C. The deblocking temperature can be controlled by catalyst, deblocking agent, solvent, etc. Then the free NCO groups will react with active hydrogens to form polymer network. By blocking agents are meant compounds which transform isocyanate groups into blocked (capped or protected) isocyanate groups, which then, below the deblocking temperature, do not display the usual reactions of a free isocyanate group. Examples of suitable blocking agents for NCO groups include oximes, phenols, imidazoles, pyrazoles, pyrazolinones, triazoles, diketopiperazines, caprolactam, malonic esters or compounds as specified in the publications by Z. W. Wicks, Prog. Org. Coat. 3 (1975) 73-99 and Prog. Org. Coat 9 (1981), 3-28, by D. A. Wicks and Z. W. Wicks, Prog. Org. Coat. 36 (1999), 148-172 and Prog. Org. Coat. 41 (2001), 1-83 and also in Houben-Weyl, Methoden der Organischen Chemie, Vol. XIV/2, 61 ff. Georg Thieme Verlag, Stuttgart 1963.

For example, suitable blocking agent for forming component (A) may be selected from the group consisting of an oxime such as methyl ethyl ketooxime, or dimethyl ketoxime; a lactam such as caprolactam, piperidones, ketopyrrolidine, or lauryl lactam, preferably ε-caprolactam; a diketone such as acetoacetic acid diester, an imidazole such as imidazole or 2-ethylimidazole, or a phenolic compound such as m-cresol.

The amount of component (A) can be in the range from 0.1 to 85% by weight, for example 0.2% by weight, 0.3% by weight, 0.4% by weight, 0.5% by weight, 0.6% by weight, 0.7% by weight, 0.8% by weight, 0.9% by weight, 1.0% by weight, 5% by weight, 10% by weight, 15% by weight, 20% by weight, 25% by weight, 30% by weight, 35% by weight, 40% by weight, 45% by weight, 50% by weight, 55% by weight, 60% by weight, 65% by weight, 70% by weight, 75% by weight, 80% by weight, 85% by weight, preferably from 0.5 to 70% by weight, or 5 to 65% by weight, or 10 to 60% by weight, or 15 to 55% by weight, or 1 to 70% by weight, 1 to 60% by weight, 5 to 55% by weight, 10 to 50% by weight, based on the total weight of the composition of the present invention.

As unreactive blocked diisocyanate of the present invention, non-limiting examples may be BL-16, TDI/polyether, blocked by methyl ethyl ketone oxime (MEKO), from Lanxess; and BLM-500, LF MDI/polyether, blocked by MEKO, from Lanxess.

### Diamine (B)

The curable composition of the present invention comprises at least one unreactive blocked diamine as component (B).

Diamine suitable for forming component (B) of the present invention may be selected from any organic compound having two amino groups per molecule, including not only those in which the amino groups are attached to a hydrocarbon radical but also those in which the amino groups are attached to a radical including a heteroatom such as oxygen or nitrogen, for example as part of ester groups, ether groups, and the like, as well as combinations of these.

Amino group of the diamine suitable for forming component (B) of the present invention may be primary amino group and/or secondary amino group.

Diamine suitable for forming component (B) of the present invention may be an aliphatic diamine, cycloaliphatic diamine, aromatic diamine, aliphatic-aromatic diamine, cycloaliphatic-aromatic diamine, aliphatic-cycloaliphatic diamine and the combination thereof.

Suitable diamines for the present invention may be those of the formula NH₂-R¹-NH₂ or NHR²-R¹-NHR³, in which the radical R¹ may be linear or else cyclic divalent hydrocarbyl, aliphatic or else aromatic divalent hydrocarbyl, having 3 to 40 carbon atoms, more preferably having 3 to 30 carbon atoms; R² and R³, independently from each other, are C₁-C₁₀-alkyl, C₆-C₂₀-aryl, C₇-C₂₀-arylalkyl, C₇-C₂₀-alkylaryl or C₇-C₂₀-cycloalkyl.

Examples of preferred diamines are ethylenediamine, propylenediamines (1,2-diaminopropane and 1,3-diaminopropane), tetramethylenediamine (1,4-diaminobutane), 1,5-diaminopentane, 1,3-diamino-2,2-diethylpropane, 1,3-bis(methylamino)propane, hexamethylenediamine (1,6-diaminohexane), heptanediamine, octanediamine, nonanediamine, decanediamine, dodecanediamine, hexadecanediamine, tolylenediamine, xylylenediamine, diaminodiphenylmethane, diaminodicyclohexylmethane, phenylenediamine, cyclohexylenediamine, bis(aminomethyl)cyclohexane, diaminodiphenyl sulfone, 1,5-diamino-2-methylpentane, 3-(propylamino) propylamine, N,N′-bis(3-aminopropyl) piperazine, isophoronediamine (IPDA), 3(or 4),8(or 9)-bis(aminomethyl)-tricyclo[5.2.1.0^{2.6]}decane isomer mixtures, 2-butyl-2-ethyl-1,5-pentamethylenediamine, 2,2,4- or 2,4,4-trimethyl-1,6-hexamethylenediamine, 2-aminopropylcyclohexylamine, 3(4)-aminomethyl-1-methylcyclohexylamine, 1,4-diamino-4-methylpentane, amine-terminated polyoxyalkylene polyols (so-called Jeffamines) or amine-terminated polytetramethylene glycols, or any combinations thereof.

Preference is given to diamines selected from the group consisting of butylenediamine, pentanediamine, hexamethylenediamine, tolylenediamine, xylylenediamine, diaminodiphenylmethane, diaminodicyclohexylmethane, phenylenediamine, cyclohexylenediamine, isophoronediamine, bis(aminomethyl) cyclohexane; and diamines of the NHR²-R¹-NHR³, wherein R¹ is C₃-C₁₀-alkylene and R² and R³ independently from each other are methyl, ethyl, propyl, and butyl; and the combination thereof.

In the present invention, diamine prepolymer having two primary or secondary amino groups may also be used as diamine suitable for forming component (B) of the present invention. For example, the diamine prepolymer may have a formula of NH₂-P-NH₂ or NHR²-P-NHR³, wherein P may be aliphatic, cycloaliphatic, aromatic, aliphatic-aromatic cycloaliphatic-aromatic, aliphatic-cycloaliphatic polyester moiety, polyether moiety, polyurethane moiety, or polyurea moiety, or the combination thereof, preferably P is aliphatic, cycloaliphatic, aromatic, aliphatic-aromatic cycloaliphatic-aromatic, aliphatic-cycloaliphatic polyester moiety, polyether moiety, or polyurethane moiety, more preferably P is aliphatic polyester moiety, polyether moiety, or polyurethane moiety, wherein R² and R³ may have the same definition as above.

In the present invention, component (B) is formed by blocking diamines with a ligand. The term “unreactive blocked diamine” means the blocked diamine will not react under radiation-curing conditions.

There is no limiting on the selection of the ligand for the present invention. The ligand can be selected by a skilled person depending on practical applications. Generally, examples of the ligand comprise monodentate ligand, such as F⁻, Cl⁻, Br⁻, I⁻, CN⁻, SCN⁻, NCS⁻, OH⁻, nitro, NO₂⁻, CH₃COO⁻, SO₃²⁻; S₂O₃²⁻, and carbonyl; bidentate ligand, such as ethylenediamine, 1,10-phenanthroline (phen), 8-Hydroxyquinoline, H₂N-CH₂-COO⁻, and C₂O₄²⁻, polydentate ligand, such as diethylenetriamine (DEN), nitrilotriacetic acid (NTA), and ethylenediaminetetraacetic acid (EDTA).

The unreactive blocked diamine of the present invention will release two free amino groups per molecule after deblocking, including primary amino group and/or secondary amino group.

The amount of component (B) can be in the range from 0.1 to 85% by weight, for example 0.2% by weight, 0.3% by weight, 0.4% by weight, 0.5% by weight, 0.6% by weight, 0.7% by weight, 0.8% by weight, 0.9% by weight, 1.0% by weight, 5% by weight, 10% by weight, 15% by weight, 20% by weight, 25% by weight, 30% by weight, 35% by weight, 40% by weight, 45% by weight, 50% by weight, 55% by weight, 60% by weight, 65% by weight, 70% by weight, 75% by weight, 80% by weight, 85% by weight, preferably from 0.5 to 70% by weight, or 5 to 65% by weight, or 10 to 60% by weight, or 15 to 55% by weight, or 1 to 70% by weight, 1 to 60% by weight, 5 to 55% by weight, 10 to 50% by weight, based on the total weight of the composition of the present invention.

Preferably, in the curable composition of the present invention, amount of component (B) is chosen such that after deblocking component (A) and component (B), the molar ratio of isocyanate group to amino group in the composition is in a range from 1.3 to 0.7, preferably in a range from 1.2 to 0.8, more preferably in a range from 1.1 to 0.9.

As unreactive blocked diamine of the present invention, non-limiting examples may be Xylink 311, a complex of 4,4′-diaminodiphenylmethane with NaCl, from Suzhou Xiangyuan New Material Co., Jiangsu, China; and Duracure C3, about 44% MDA-NaCl salt dispersed in Dioctyl adipate, commercially available from Lanxess.

### Reactive Component (C)

The curable composition of the present invention comprises at least one reactive component as component (C). Generally, reactive components usable for 3D-printing may be used in the present invention as reactive component (C). Reactive component (C) of the present invention contains at least one radiation-curable functional group.

In an embodiment of the present invention, reactive component (C) of the present invention comprises a monomer and/or oligomer containing at least one radiation-curable functional group.

The radiation-curable functional group of reactive component (C) of the present invention may be selected from the group consisting of an ethylenically unsaturated functional group, an epoxy group, or the mixture thereof. For example, the at least one radiation-curable functional group of the monomer and/or oligomer containing at least one radiation-curable functional group suitable as reactive component (C) is selected from the group consisting of an ethylenically unsaturated functional group, an epoxy group, or the mixture thereof.

Preferably, the number of the radiation-curable functional group in reactive component (C) is in the range from 1 to 12, preferably from 1 to 10, such as from 1 to 8, per molecule of reactive component (C).

As reactive component (C) containing at least one epoxy group, non-limiting examples may include epoxidized olefins, aromatic glycidyl ethers, aliphatic glycidyl ethers, or the combination thereof, preferably aromatic or aliphatic glycidyl ethers.

Examples of possible epoxidized olefins include epoxidized C₂-C₁₀-olefins, such as ethylene oxide, propylene oxide, iso-butylene oxide, 1-butene oxide, 2-butene oxide, vinyloxirane, styrene oxide or epichlorohydrin, preference being given to ethylene oxide, propylene oxide, isobutylene oxide, vinyloxirane, styrene oxide or epichlorohydrin, particular preference to ethylene oxide, propylene oxide or epichlorohydrin, and very particular preference to ethylene oxide and epichlorohydrin.

Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy) henyl]octahydro-4,7-methano-5H-indene (CAS No. [13446-85-0]), tris[4-(2,3-epoxypropoxy)phenyl]methane isomers (CAS No. [66072-39-7]), phenol-based epoxy novolaks (CAS No.[9003-35-4]), and cresol-based epoxy novolaks (CAS No. [37382-79-9]).

Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ψ-bis(2,3-epoxypropoxy) poly(oxypropylene), CAS No. [16096-30-3]) and of hydrogenated bisphenol A (2,2-bis[4-(2,3-epoxypropoxy)cyclohexyl]propane, CAS No. [13410-58-7]).

More preferably, reactive component (C) of the present invention contains at least one ethylenically unsaturated functional group.

In an embodiment of the invention, the ethylenically unsaturated functional group contains a carbon-carbon unsaturated bond, such as those found in the following functional groups: allyl, vinyl, acrylate, methacrylate, acryloxy, methacryloxy, acrylamido, methacrylamido, acetylenyl, maleimido, and the like; preferably, the ethylenically unsaturated functional group contains a carbon-carbon unsaturated double bond.

In a preferred embodiment of the invention, reactive component (C) of the present invention contains, in addition to the ethylenically unsaturated functional group and/or epoxy group, urethane groups, ether groups, ester groups, carbonate groups, and any combination thereof.

As reactive component (C) of the present invention, the oligomer containing at least one radiation-curable functional group includes, for example, oligomers containing a core structure linked to the ethylenically unsaturated functional group, optionally via a linking group. The linking group can be an ether, ester, amide, urethane, carbonate, or carbonate group. In some instances, the linking group is part of the ethylenically unsaturated functional group, for instance an acryloxy or acrylamido group. The core group can be an alkyl (straight and branched chain alkyl groups), aryl (e.g. phenyl), polyether, polyester, siloxane, urethane, or other core structures and oligomers thereof. Suitable ethylenically unsaturated functional group may comprise groups containing carbon-carbon double bond, such as methacrylate groups, acrylate groups, vinyl ether groups, allyl ether groups, acrylamide groups, methacrylamide groups, or a combination thereof. In some embodiments, suitable oligomers comprise mono-and/or polyfunctional acrylate, such as mono (meth)acrylate, di(meth)acrylate, tri(meth)acrylate, or higher, or combination thereof. Optionally, the oligomer may include a siloxane backbone in order to further improve cure, flexibility and/or additional properties of the radiation-curable composition for 3D printing.

In some embodiments, the oligomer containing at least one ethylenically unsaturated functional group can be selected from the following classes: urethane (i.e. an urethane-based oligomer containing ethylenically unsaturated functional group), polyether (i.e. an polyether-based oligomer containing ethylenically unsaturated functional group), polyester (i.e. an polyester-based oligomer containing ethylenically unsaturated functional group), polycarbonate (i.e. an polycarbonate-based oligomer containing ethylenically unsaturated functional group), polyestercarbonate (i.e. an polyestercarbonate-based oligomer containing ethylenically unsaturated functional group), epoxy (i.e. an epoxy-based oligomer containing ethylenically unsaturated functional group), silicone (i.e. a silicone-based oligomer containing ethylenically unsaturated functional group) or any combination thereof. Preferably, the oligomer containing at least one ethylenically unsaturated functional group can be selected from the following classes: a urethane-based oligomer, an epoxy-based oligomer, a polyester-based oligomer, a polyether-based oligomer, polyether urethane-based oligomer, polyester urethane-based oligomer or a silicone-based oligomer, as well as any combination thereof.

In a preferred embodiment of the invention, the oligomer containing at least one ethylenically unsaturated functional group comprises a urethane-based oligomer comprising urethane repeating units and one, two or more ethylenically unsaturated functional groups, for example those containing carbon-carbon unsaturated double bond, such as (meth)acrylate groups, (meth)acrylamide groups, allyl groups and vinyl groups. Preferably, the oligomer contains at least one urethane linkage (for example, one, two or more urethane linkages) within the backbone of the oligomer molecule and at least one acrylate and/or methacrylate functional groups (for example, one, two or more acrylate and/or methacrylate functional groups) pendent to the oligomer molecule. In some embodiments, aliphatic, cycloaliphatic, or mixed aliphatic and cycloaliphatic urethane repeating units are suitable. Urethanes are typically prepared by the condensation of a diisocyanate with a diol. Aliphatic urethanes having at least two urethane moieties per repeating unit are useful. In addition, the diisocyanate and diol used to prepare the urethane comprise divalent aliphatic groups that may be the same or different.

In one embodiment, the oligomer containing at least one ethylenically unsaturated functional group comprises polyester urethane-based oligomer or polyether urethane-based oligomer containing at least one ethylenically unsaturated functional group. The ethylenically unsaturated functional group can be those containing carbon-carbon unsaturated double bond, such as acrylate groups, methacrylate groups, vinyl groups, allyl groups, acrylamide groups, methacrylamide groups etc., preferably acrylate groups and methacrylate groups. Suitable urethane-based oligomers are known in the art and may be readily synthesized by a number of different procedures. For example, a polyfunctional alcohol may be reacted with a polyisocyanate (preferably, a stoichiometric excess of polyisocyanate) to form an NCO-terminated pre-oligomer, which is thereafter reacted with a hydroxy-functional ethylenically unsaturated monomer, such as hydroxy-functional (meth)acrylate. The polyfunctional alcohol may be any compound containing two or more OH groups per molecule and may be a monomeric polyol (e.g., a glycol), a polyester polyol, a polyether polyol or the like. The urethane-based oligomer in one embodiment of the invention is an aliphatic urethane-based oligomer containing (meth)acrylate functional group.

Suitable polyether or polyester urethane-based oligomers include the reaction product of an aliphatic or aromatic polyether or polyester polyol with an aliphatic or aromatic polyisocyanate that is functionalized with a monomer containing the ethylenically unsaturated functional group, such as (meth)acrylate group. In a preferred embodiment, the polyether and polyester are aliphatic polyether and polyester, respectively. In a preferred embodiment, the polyether and polyester urethane-based oligomers are aliphatic polyether and polyester urethane-based oligomers and comprise (meth)acrylate group.

In one embodiment, the viscosity of the oligomer containing at least one ethylenically unsaturated functional group at 60° C. can be in the range from 200 to 200000 cP, for example 500 cP, 800 cP, 1000 cP, 2000 cP, 3000 cP, 4000 cP, 5000 cP, 6000 cP, 7000 cP, 8000 cP, 10000 cP, 20000 cP, 30000 cP, 40000 cP, 50000 cP, 60000 cP, 70000 cP, 80000 cP, 90000 cP, 95000 cP, preferably 500 to 60000cP, for example 1000 to 50000 cP, 2000 to 40000 cP, 3000 to 20000 cP, 4000 to 15000 cP, or 20000 cP to 60000 cP, as measured according to DIN EN ISO 3219.

The monomer can lower the viscosity of the composition. The monomer can be monofunctional or multifunctional (such as difunctional, trifunctional). In one embodiment, the monomer can be selected from the group consisting of (meth)acrylate monomers, (meth)acrylamide monomers, vinylaromatics having up to 20 carbon atoms, vinyl esters of carboxylic acids having up to 20 carbon atoms, xx,B-unsaturated carboxylic acids having 3 to 8 carbon atoms and their anhydrides, and vinyl substituted heterocycles,

In the context of the present disclosure, the term “(meth)acrylate monomer” means a monomer comprises a (meth)acrylate moiety. The structure of the (meth)acrylate moiety is as follows:

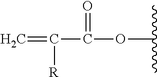

wherein R is H or methyl.

The (meth)acrylate monomer can be monofunctional or multifunctional (such as difunctional, trifunctional) (meth)acrylate monomer. Exemplary (meth)acrylate monomer can include C₁ to C₂₀ alkyl (meth)acrylate, C₁ to C₁₀ hydroxyalkyl (meth)acrylate, C₃ to C₁₀ cycloalkyl (meth)acrylate, urethane acrylate, 2-(2-ethoxy) ethyl acrylate, tetrahydrofurfuryl (meth)acrylate, 2-phenoxyethylacrylate, dicyclopentenyloxyethyl (meth)acrylate, dicyclopentadienyl (meth)acrylate, caprolactone (meth)acrylate, morpholine (meth)acrylate, ethoxylated nonyl phenol (meth)acrylate, (5-ethyl-1,3-dioxan-5-yl) methyl acrylate, phenyl (meth)acrylate, benzyl (meth)acrylate, phenethyl (meth)acrylate, dicyclopentanyl (meth)acrylate, 3,3,5-trimethylcyclohexyl (meth)acrylate and dicyclopentenyl (meth)acrylate.

Specific examples of C₁ to C₂₀ alkyl (meth)acrylate can include methyl (meth)acrylate, ethyl (meth)acrylate, isopropyl (meth)acrylate, n-propyl (meth)acrylate, n-butyl (meth)acrylate, isobutyl (meth)acrylate, tert-butyl (meth)acrylate, sec-butyl (meth)acrylate, pentyl (meth)acrylate, n-hexyl (meth)acrylate, octyl (meth)acrylate, isooctyl (meth)acrylate, 2-ethylhexyl (meth)acrylate, decyl (meth)acrylate, isodecyl (meth)acrylate, n-lauryl (meth)acrylate, n-tridecyl (meth)acrylate, n-cetyl (meth)acrylate, n-stearyl (meth)acrylate, isomyristyl (meth)acrylate, stearyl (meth)acrylate, and isostearyl (meth)acrylate (ISTA). C₆ to C₁₈ alkyl (meth)acrylate, especially C₆ to C₁₆ alkyl (meth)acrylate or Cs to C₁₂ alkyl (meth)acrylate is preferred.

Specific examples of C₁ to C₁₀ hydroxyalkyl (meth)acrylate, such as C₂ to C₈ hydroxyalkyl (meth)acrylate can include 2-hydroxyethyl (meth)acrylate, 2-hydroxypropyl (meth)acrylate, 3-hydroxypropyl (meth)acrylate, 3-hydroxybutyl (meth)acrylate, 4-hydroxybutyl (meth)acrylate, 6-hydroxyhexyl (meth)acrylate, or 3-hydroxy-2-ethylhexyl (meth)acrylate etc.

Specific examples of C₃ to C₁₀ cycloalkyl (meth)acrylate can include isobornyl acrylate, isobornyl methacrylate, cyclohexyl acrylate or cyclohexyl methacrylate.

Examples of the multifunctional (meth)acrylate monomer can include (meth) acrylic esters and especially acrylic esters of polyfunctional alcohols, particularly those which other than the hydroxyl groups comprise no further functional groups or, if they comprise any at all, comprise ether groups. Examples of such alcohols are, e.g., difunctional alcohols, such as ethylene glycol, propylene glycol, and their counterparts with higher degrees of condensation, for example such as diethylene glycol, triethylene glycol, dipropylene glycol, tripropylene glycol etc., 1,2-, 1,3- or 1,4-butanediol, 1,5-pentanediol, 1,6-hexanediol, 3-methyl-1,5-pentanediol, neopentyl glycol, alkoxylated phenolic compounds, such as ethoxylated and/or propoxylated bisphenols, 1,2-, 1,3- or 1,4-cyclohexanedimethanol, alcohols with a functionality of three or higher, such as glycerol, trimethylolpropane, butanetriol, trimethylolethane, pentaerythritol, ditrimethylolpropane, dipentaerythritol, sorbitol, mannitol, and the corresponding alkoxylated, especially ethoxylated and/or propoxylated, alcohols.

In the context of the present disclosure, term “(meth)acrylamide monomer” means a monomer comprises a (meth)acrylamide moiety. The structure of the (meth)acrylamide moiety is as follows: CH₂═CR¹—CO—N, wherein R¹ is hydrogen or methyl. Specific example of (meth)acrylamide monomer can include acryloylmorpholine, methacryloylmorpholine, N-(hydroxymethyl) acrylamide, N-hydroxyethyl acrylamide, N-isopropylacrylamide, N-isopropylmethacrylamide, N-tert-butylacrylamide, N,N′-methylenebisacrylamide, N-(isobutoxymethyl)acrylamide, N-(butoxymethyl)acrylamide, N-[3-(dimethylamino)propyl]methacrylamide, N,N-dimethylacrylamide, N,N-diethylacrylamide, N-(hydroxymethyl) methacrylamide, N-hydroxyethyl methacrylamide, N-isopropylmethacrylamide, N-isopropylmethacrylamide, N-tert-butylmethacrylamide, N,N′-methylenebismethacrylamide, N-(isobutoxymethyl) methacrylamide, N-(butoxymethyl)methacrylamide, N-[3-(dimethylamino)propyl]methacrylamide, N,N-dimethylmethacrylamide and N,N-diethylmethacrylamide. The (meth)acrylamide monomer can be used alone or in combination.

Examples of vinylaromatics having up to 20 carbon atoms can include, such as styrene and C₁-C₄-alkyl substituted styrene, such as vinyltoluene, p-tert-butylstyrene and a-methyl styrene.

Examples of vinyl esters of carboxylic acids having up to 20 carbon atoms (for example 2 to 20 or 8 to 18 carbon atoms) can include vinyl laurate, vinyl stearate, vinyl propionate, and vinyl acetate.

Example of α,β-unsaturated carboxylic acids having 3 to 8 carbon atoms can be acrylic acid or methacrylic acid.

Examples of vinyl substituted heterocycles can include monovinyl substituted heterocycles, wherein the heterocycle is a 5-to 8-membered ring containing 2 to 7 carbon atoms, and 1 to 4 (preferably 1 or 2) heteroatoms selected from N, O and S, such as vinylpyridines, N-vinylpyrrolidone, N-vinylmorpholin-2-one, N-vinyl caprolactam and 1-vinylimidazole, vinyl alkyl oxazolidinone such as vinyl methyl oxazolidinone.

Preferred monomers are (meth)acrylate monomer, (meth)acrylamide monomer, vinylaromatics having up to 20 carbon atoms, and vinyl substituted heterocycles.

In a preferred embodiment, reactive component (C) of the present invention comprises both the oligomer and the monomer containing at least one ethylenically unsaturated functional group. The weight ratio of the oligomer to the monomer can be in the range from 10:1 to 1:10, preferably from 8:1 to 1:8, or from 5:1 to 1:5, or from 3:1 to 1:5, or from 1:1 to 1:4.

The amount of reactive component (C) can be in the range from 10 to 99% by weight, for example 20% by weight, 25% by weight, 30% by weight, 35% by weight, 40% by weight, 45% by weight, 50% by weight, 55% by weight, 60% by weight, 70% by weight, 80% by weight, 85% by weight, 90% by weight, 92% by weight, 95% by weight, 96% by weight, 98% by weight, 99% by weight, preferably from 10 to 99% by weight, or 12to 99% by weight, or 20 to 99% by weight, or 24 to 99% by weight, or 25 to 99% by weight, 30 to 99% by weight, 35 to 99% by weight, 20 to 90% by weight, 25 to 90% by weight, 30 to 90% by weight, 35 to 90% by weight, 20 to 80% by weight, 25 to 80% by weight, 30 to 80% by weight, 35 to 80% by weight, 20 to 70% by weight, 25 to 70% by weight, 30 to 70% by weight, 35 to 70% by weight, based on the total weight of the composition of the present invention. Generally, the amount of reactive component (C) depends on the 3D printing machine with different requirements on viscosity etc.

### Photo-Initiator (D)

The curable composition of the present invention comprises at least one photo-initiator as component (D). For example, photo-initiator component (D) may include at least one free radical photo-initiator and/or at least one ionic photo-initiator, and preferably at least one (for example one or two) free radical photo-initiator. It is possible to use all photo-initiators known in the art for use in compositions for 3D-printing, e.g., it is possible to use photo-initiators that are known in the art suitable for SLA, DLP or PPJ processes.

As examples of the photo-initiator for the present invention, it is possible to use those referred to in “Advances in Polymer Science”, Volume 14, Springer Berlin 1974 or in K. K. Dietliker, Chemistry and Technology of UV and EB Formulation for Coatings, Inks and Paints, Volume 3; Photo-initiators for Free Radical and Cationic Polymerization, P. K. T. Oldring (Ed.), SITA Technology Ltd, London.

Suitable examples include phosphine oxides, benzophenones, a-hydroxyalkyl aryl ketones, thioxanthones, anthraquinones, acetophenones, benzoins and benzoin ethers, ketals, imidazoles or phenylglyoxylic acids, and mixtures thereof.

Phosphine oxides are for example monoacyl-or bisacylphosphine oxides, such as Irgacure®819 (bis(2,4,6-trimethylbenzoyl) phenylphosphine oxide), as described for example in EP-A 7 508, EP-A 57 474, DE-A 196 18 720, EP-A 495 751 or EP-A 615 980, such as 2,4,6-trimethylbenzoyldiphenylphosphine oxide (Lucirin® TPO), ethyl 2,4,6-trimethylbenzoylphenylphosphinate or bis(2,6-dimethoxybenzoyl)-2,4,4-trimethylpentylphosphine oxide;
Benzophenones are for example benzophenone, 4-aminobenzophenone, 4,4′-bis(dimethylamino)benzophenone, 4-phenylbenzophenone, 4-chlorobenzophenone, Michler's ketone, o-methoxybenzophenone, 2,4,6-trimethylbenzophenone, 4-methylbenzophenone, 2,4-dimethylbenzophenone, 4-isopropylbenzophenone, 2-chlorobenzophenone, 2,2′-dichlorobenzophenone, 4-methoxybenzophenone, 4-propoxybenzophenone or 4-butoxybenzophenone;
α-hydroxyalkyl aryl ketones are for example 1-benzoylcyclohexan-1-ol (1-hydroxycyclohexyl phenyl ketone), 2-hydroxy-2,2-dimethylacetophenone (2-hydroxy-2-methyl-1-phenylpropan-1-one), 1-hydroxyacetophenone, 1-[4-(2-hydroxyethoxy) phenyl]-2-hydroxy-2-methyl-1-propan-1-one or polymer containing 2-hydroxy-2-methyl-1-(4-isopropen-2-ylphenyl)propan-1-one in copolymerized form (Esacure® KIP 150);
Xanthones and thioxanthones are for example 10-thioxanthenone, thioxanthen-9-one, xanthen-9-one, 2,4-dimethylthioxanthone, 2,4-diethylthioxanthone, 2,4-diisopropylthioxanthone, 2,4-dichlorothioxanthone or chloroxanthenone;
Anthraquinones are for example B-methylanthraquinone, tert-butylanthraquinone, anthraquinonecarboxylic esters, benz[de] anthracen-7-one, benz[a]anthracen-7,12-dione, 2-methylanthraquinone, 2-ethylanthraquinone, 2-tert-butylanthraquinone, 1-chloroanthraquinone or 2-amylanthraquinone;
Acetophenones are for example acetophenone, acetonaphthoquinone, valerophenone, hexanophenone, α-phenylbutyrophenone, p-morpholinopropiophenone, dibenzosuberone, 4-morpholinobenzophenone, p-diacetylbenzene, 4′-methoxyacetophenone, α-tetralone, 9-acetylphenanthrene, 2-acetylphenanthrene, 3-acetylphenanthrene, 3-acetylindole, 9-fluorenone, 1-indanone, 1,3,4-triacetylbenzene, 1-acetonaphthone, 2-acetonaphthone, 2,2-dimethoxy-2-phenylacetophenone, 2,2-diethoxy-2-phenylacetophenone, 1,1-dichloroacetophenone, 1-hydroxyacetophenone, 2,2-diethoxyacetophenone, 2-methyl-1-[4-(methylthio)phenyl]-2-morpholinopropan-1-one, 2,2-dimethoxy-1,2-diphenylethan-2-one or 2-benzyl-2-dimethylamino-1-(4-morpholinophenyl)butan-1-one;
Benzoins and benzoin ethers are for example 4-morpholinodeoxybenzoin, benzoin, benzoin isobutyl ether, benzoin tetrahydropyranyl ether, benzoin methyl ether, benzoin ethyl ether, benzoin butyl ether, benzoin isopropyl ether or 7H-benzoin methyl ether; and
Ketals are for example acetophenone dimethyl ketal, 2,2-diethoxyacetophenone, or benzil ketals, such as benzil dimethyl ketal.

Phenylglyoxylic acids are described for example in DE-A 198 26 712, DE-A 199 13 353 or WO 98/33761.

Photo-initiators which can be used as well are for example benzaldehyde, methyl ethyl ketone, 1-naphthaldehyde, triphenylphosphine, tri-o-tolylphosphine or 2,3-butaned-ione.

Appropriate mixtures of photo-initiators may also be used. Typical mixtures include for example:

2-hydroxy-2-methyl-1-phenylpropan-2-one and 1-hydroxycyclohexyl phenyl ketone;
bis(2,6-dimethoxybenzoyl)-2,4,4-trimethylpentylphosphine oxide and 2-hydroxy-2-methyl-1-phenylpropan-1-one;
benzophenone and 1-hydroxycyclohexyl phenyl ketone;
bis(2,6-dimethoxybenzoyl)-2,4,4-trimethylpentylphosphine oxide and 1-hydroxycyclohexyl phenyl ketone;
2,4,6-trimethylbenzoyldiphenylphosphine oxide and 2-hydroxy-2-methyl-1-phenylpropan-1-one;
2,4,6-trimethylbenzophenone and 4-methylbenzophenone; or
2,4,6-trimethylbenzophenone, and 4-methylbenzophenone and 2,4,6-trimethylbenzoyldiphenylphosphine oxide.

The amount of the photo-initiator (D) can be in the range from 0.1 to 10% by weight, for example 0.2% by weight, 0.5% by weight, 0.8% by weight, 1% by weight, 2% by weight, 3% by weight, 5% by weight, 8% by weight, or 10% by weight, preferably from 0.1 to 8% by weight or 0.1 to 5% by weight, based on the total weight of the composition of the present invention.

In one embodiment, the curable composition of the present invention comprises following components:
(A) 0.1 to 85% by weight of at least one unreactive blocked diisocyanate;
(B) 0.1 to 85% by weight of at least one unreactive blocked diamine;
(C) 10 to 99% by weight of at least one reactive component; and
(D) 0.1 to 10% by weight of at least one photo-initiator,
wherein component (B) is formed by blocking diamine with a ligand.

In one embodiment, the curable composition of the present invention comprises following components:
(A) 0.1 to 85% by weight of at least one unreactive blocked diisocyanate;
(B) 0.1 to 85% by weight of at least one unreactive blocked diamine;
(C) 10 to 99% by weight of at least one reactive component; and
(D) 0.1 to 8% by weight of at least one photo-initiator,
wherein component (B) is formed by blocking diamine with a ligand.

In one embodiment, the curable composition of the present invention comprises following components:
(A) 0.1 to 85% by weight of at least one unreactive blocked diisocyanate;
(B) 0.1 to 85% by weight of at least one unreactive blocked diamine;
(C) 10 to 99% by weight of at least one reactive component; and
(D) 0.1 to 5% by weight of at least one photo-initiator, wherein component (B) is formed by blocking diamine with a ligand.

In one embodiment, the curable composition of the present invention comprises following components:
(A) 0.5 to 65% by weight of at least one unreactive blocked diisocyanate;
(B) 0.5 to 65% by weight of at least one unreactive blocked diamine;
(C) 30 to 90% by weight of at least one reactive component; and
(D) 0.1 to 10% by weight of at least one photo-initiator,
wherein component (B) is formed by blocking diamine with a ligand.

In one embodiment, the curable composition of the present invention comprises following components:
(A) 0.5 to 65% by weight of at least one unreactive blocked diisocyanate;
(B) 0.5 to 65% by weight of at least one unreactive blocked diamine;
(C) 30 to 90% by weight of at least one reactive component; and
(D) 0.1 to 8% by weight of at least one photo-initiator,
wherein component (B) is formed by blocking diamine with a ligand.

In one embodiment, the curable composition of the present invention comprises following components:
(A) 0.5 to 65% by weight of at least one unreactive blocked diisocyanate;
(B) 0.5 to 65% by weight of at least one unreactive blocked diamine;
(C) 30 to 90% by weight of at least one reactive component; and
(D) 0.1 to 5% by weight of at least one photo-initiator,
wherein component (B) is formed by blocking diamine with a ligand.

In one embodiment, the curable composition of the present invention comprises following components:
(A) 1 to 60% by weight of at least one unreactive blocked diisocyanate;
(B) 1 to 60% by weight of at least one unreactive blocked diamine;
(C) 35 to 90% by weight of at least one reactive component; and
(D) 0.1 to 10% by weight of at least one photo-initiator,
wherein component (B) is formed by blocking diamine with a ligand.

In one embodiment, the curable composition of the present invention comprises following components:
(A) 1 to 60% by weight of at least one unreactive blocked diisocyanate;
(B) 1 to 60% by weight of at least one unreactive blocked diamine;
(C) 35 to 90% by weight of at least one reactive component; and
(D) 0.1 to 8% by weight of at least one photo-initiator,
wherein component (B) is formed by blocking diamine with a ligand.

In one embodiment, the curable composition of the present invention comprises following components:
(A) 1 to 60% by weight of at least one unreactive blocked diisocyanate;
(B) 1 to 60% by weight of at least one unreactive blocked diamine;
(C) 35 to 90% by weight of at least one reactive component; and
(D) 0.1 to 5% by weight of at least one photo-initiator,
wherein component (B) is formed by blocking diamine with a ligand.

In one embodiment, the curable composition of the present invention comprises following components:
(A) 5 to 55% by weight of at least one unreactive blocked diisocyanate;
(B) 5 to 55% by weight of at least one unreactive blocked diamine;
(C) 30 to 70% by weight of at least one reactive component; and
(D) 0.1 to 10% by weight of at least one photo-initiator,
wherein component (B) is formed by blocking diamine with a ligand.

In one embodiment, the curable composition of the present invention comprises following components:
(A) 5 to 55% by weight of at least one unreactive blocked diisocyanate;
(B) 5 to 55% by weight of at least one unreactive blocked diamine;

(C) 30 to 70% by weight of at least one reactive component; and
(D) 0.1 to 8% by weight of at least one photo-initiator,
wherein component (B) is formed by blocking diamine with a ligand.

In one embodiment, the curable composition of the present invention comprises following components:
(A) 5 to 55% by weight of at least one unreactive blocked diisocyanate;
(B) 5 to 55% by weight of at least one unreactive blocked diamine;
(C) 30 to 70% by weight of at least one reactive component; and
(D) 0.1 to 5% by weight of at least one photo-initiator,
wherein component (B) is formed by blocking diamine with a ligand.

In one embodiment, the curable composition of the present invention comprises following components:
(A) 10 to 50% by weight of at least one unreactive blocked diisocyanate;
(B) 10 to 50% by weight of at least one unreactive blocked diamine;
(C) 35 to 70% by weight of at least one reactive component; and
(D) 0.1 to 10% by weight of at least one photo-initiator,
wherein component (B) is formed by blocking diamine with a ligand.

In one embodiment, the curable composition of the present invention comprises following components:
(A) 10 to 50% by weight of at least one unreactive blocked diisocyanate;
(B) 10 to 50% by weight of at least one unreactive blocked diamine;
(C) 35 to 70% by weight of at least one reactive component; and
(D) 0.1 to 8% by weight of at least one photo-initiator,
wherein component (B) is formed by blocking diamine with a ligand.

In one embodiment, the curable composition of the present invention comprises following components:
(A) 10 to 50% by weight of at least one unreactive blocked diisocyanate;
(B) 10 to 50% by weight of at least one unreactive blocked diamine;
(C) 35 to 70% by weight of at least one reactive component; and
(D) 0.1 to 5% by weight of at least one photo-initiator,
wherein component (B) is formed by blocking diamine with a ligand.

### Component (E)

For practical applications, optionally, the curable composition of the present invention may further comprise auxiliary agents as component (E).

As auxiliary agents, mention may be made by way of preferred example of surfactants, diluents, flame retardants, nucleating agents, lubricant, dyes, pigments, catalyst, UV absorbers and stabilizers, e.g. against oxidation, hydrolysis, light, heat or discoloration, inorganic and/or organic fillers, reinforcing materials and plasticizers. As hydrolysis inhibitors, preference is given to oligomeric and/or polymeric aliphatic or aromatic carbodiimides. To stabilize the cured material of the invention against aging and damaging environmental influences, stabilizers are added to system in preferred embodiments.

Surfactants are surface active compounds, such as anionic, cationic, nonionic and amphoteric surfactants, and mixtures thereof. Such surfactants can be used for example as dispersant, solubilizer, and the like. Examples of surfactants are listed in Mccutcheon's, Vol. 1: Emulsifiers & Detergents, Mccutcheon's Directories, Glen Rock, USA, 2008 (International Ed. or North American Ed.). Suitable anionic surfactants may be alkali, alkaline earth or ammonium salts of sulfonates, sulfates, phosphates, carboxylates, and mixtures thereof. Suitable nonionic surfactants may be alkoxylates, N-substituted fatty acid amides, amine oxides, esters, sugar-based surfactants, polymeric surfactants, and mixtures thereof. Suitable cationic surfactants may be quaternary surfactants, for example quaternary ammonium compounds with one or two hydrophobic groups, or salts of long chain primary amines. Suitable amphoteric surfactants may be alkylbetains and imidazolines.

Suitable diluents for the present invention comprise for example (bi)cycloaliphatics such as cyclohexane and its alkylated derivatives, and also decahydronaphthalene, cyclic sulfoxides such as sulfolane, nitrogen heterocycles such as pyridine, pyrimidine, quinoline, isoquinoline, quinaldine and N-methylpyrrolidone, and also carboxamides such as N, N-dimethylformamide and N,N-dimethylacetamide.

If the composition of the invention is exposed to thermo-oxidative damage during use, in preferred embodiments, antioxidants are added. Preference is given to phenolic antioxidants. Phenolic antioxidants such as Irganox® 1010 from BASF SE are given in

Plastics Additive Handbook, 5th edition, H. Zweifel, ed., Hanser Publishers, Munich, 2001, pages 98-107, page 116 and page 121.

If the composition of the invention is exposed to UV light, it is preferably additionally stabilized with a UV absorber. UV absorbers are generally known as molecules which absorb high-energy UV light and dissipate energy. Customary UV absorbers which are employed in industry belong, for example, to the group of cinnamic esters, diphenylcyan acrylates, formamidines, benzylidenemalonates, diarylbutadienes, triazines and benzotriazoles. Examples of commercial UV absorbers may be found in Plastics Additive Handbook, 5th edition, H. Zweifel, ed, Hanser Publishers, Munich, 2001, pages 116-122.

Further details regarding the abovementioned auxiliary agents may be found in the specialist literature, e.g. in Plastics Additive Handbook, 5th edition, H. Zweifel, ed, Hanser Publishers, Munich, 2001.

Plasticizers can be used to lower the glass transition temperature (Tg) of the polymer. Plasticizers work by being embedded between the chains of polymers, spacing them apart (increasing the “free volume”), and thus lowering the glass transition temperature of the polymer and making it softer. Plasticizers may be selected by a skilled person for the present invention according to practical applications. Exemplary plasticizers include polycarboxylic acids and their esters, epoxidized vegetable oils; sulfonamides, organophosphates, glycols/polyether and their derivatives, polymeric plasticizer, biodegradable plasticizers, and the like. For example, the plasticizers can be selected from the group consisting of cyclohexane dicarboxylic acid and its esters, preferably esters of 1,2-cyclohexane dicarboxylic acid, more preferably 1,2-cyclohexane dicarboxylic acid diisononyl ester (such as Hexamoll® DINCH from BASF SE).

When present, the amount of component (E) in the curable composition of the present invention may be in the range from 0 to 60% by weight, for example 5% by weight, 10% by weight, 15% by weight, 20% by weight, 25% by weight, 30% by weight, 35% by weight, 40% by weight, 50% by weight, 60% by weight, preferably from 0 to 50% by weight, or from 0 to 40% by weight, or from 0 to 30% by weight, based on the total weight of the composition of the present invention.

### Preparation of the Composition

One aspect of the present invention relates to a process of preparing the curable composition of the present invention for 3D-printing, comprising mixing the components of the composition.

According to an embodiment of the invention, the mixing can be carried out at room temperature with stirring. There is no particular restriction on the time of mixing and rate of stirring, as long as all components are uniformly mixed together. In a specific embodiment, the mixing can be carried out at 1000 to 3000 RPM, preferably 1500 to 2500 RPM for 5 to 60 min, more preferably 6 to 30 min.

The curable composition of the present invention shows excellent long-term stability. In some embodiments of the invention, the change of the viscosity of the curable composition measured according to DIN EN ISO 3219 at 23° C. from being freshly prepared to being stored for 7 days can be less than 10%, preferably less than 8%, such as in the range of from 1 to 7%. In some embodiments of the invention, the change of the viscosity of the curable composition measured according to DIN EN ISO 3219 at 23° C. from being freshly prepared to being stored for 14 days can be less than 10%, preferably less than 6%, such as in the range of from 0.1 to 5.5%.

### 3D-Printed Object and Preparation Thereof

One aspect of the present invention relates to a process of forming 3D-printed object, comprising using the curable composition of the present invention.

In one embodiment of the present invention, the process of forming a 3D-printed object comprises the steps of:
(i) applying the composition in form of a layer, and curing the applied composition layer by layer by radiation to form an intermediate 3D-printed object;
(ii) curing the whole intermediate 3D-printed object by radiation to form a cured 3D-printed object; and
(iii) thermally curing the whole cured 3D-printed object to form a final 3D-printed object.

According to the invention, the curing time in step (i) and (ii) may be determined respectively by a skilled person according to practical application. For example, in step (i) of the process, the curing time for each layer may be from 0.5 to 15s, such as from 1 to 10 s.

In step (ii) of the process, the curing time for the whole intermediate 3D-printed object may be in the range from 10 min to 500 min, for example 20 min, 30 min, 40 min, 60 min, 80 min, 100 min, 120 min, 180 min, 250 min, 300 min, 400 min, preferably from 10 min to 250 min.

There is no specific restriction on the temperature during step (i) or step (ii). Specifically, the temperature may be selected depending on the material and the 3D printer used.

Step (iii) of the process of forming a 3D-printed object of the present invention may be carried out at the temperature of 60 to180° C., preferably 80 to 150° C., more preferably 100 to 140° C., for such as 1 hour to 48 hours, for example 2 hours, 4 hours, 6 hours, 8 hours, 10 hours, 12 hours, 16 hours, 20 hours, 24 hours, 28 hours, 32 hours, 36 hours, 40 hours, 44 hours, 48 hours, preferably for 4 hours to 36 hours, 6 hours to 36 hours, 8 hours to 36 hours, 10 hours to 24 hours, 12 hours to 24 hours, 12 hours to 20 hours, 16 hours to 36 hours, 20 hours to 36 hours, 24 hours to 36 hours, 28 hours to 36 hours. The temperature during step (iii) may be changed as required. For example, in an embodiment of the present invention, step (iii) of the process of forming a 3D-printed object of the present invention may be carried out in two stages, with the first stage being carried out at the temperature of 80° C. for one hour and the second stage being carried out at the temperature of 130° C. for 12 hours.

Radiation used in steps (i) and (ii) of the process of forming a 3D-printed object of the present invention may be adopted by a skilled person according to the practical 3D-printing applications. For example, the radiation may be actinic ray that has sufficient energy to initiate a polymerization or cross-linking reaction. The actinic ray can include but is not limited to a-rays, y-rays, ultraviolet radiation (UV radiation), visible light, and electron beams, wherein UV radiation and electron beams, especially, UV radiation is preferred.

In a specific embodiment, the wavelength of the radiation light can be in the range from 350 to 480 nm, for example 365 nm, 385 nm, 395 nm, 405 nm, 420 nm, 440nm, 460nm, 480nm.

Stereolithography (SLA), digital light processing (DLP), photopolymer jetting (PPJ), LCD technology or other techniques known by a person skilled in the art can be employed in step (i) of the process of forming 3D-printed objects of the present invention. Preferably, the production of cured 3D objects of complex shape is performed for instance by means of stereolithography, which has been known for a number of years. In this technique, the desired shaped article is built up from a radiation-curable composition with the aid of a recurring, alternating sequence of two steps (1) and (2). In step (1), a layer of the radiation-curable composition, one boundary of which is the surface of the composition, is cured with the aid of appropriate imaging radiation, preferably imaging radiation from a computer-controlled scanning laser beam, within a surface region which corresponds to the desired cross-sectional area of the shaped article to be formed, and in step (2) the cured layer is covered with a new layer of the radiation-curable composition, and the sequence of steps (1) and (2) is often repeated until the desired shape is finished.

The present invention further relates to a 3D-printed object formed from the curable composition of the present invention or obtained by the process of the present invention.

Non-limiting examples of the 3D-printed objects comprise sole, outerwear, cloth, footwear, toy, mat, tire, hose, gloves, seals, medical appliances such as hearing aids, dental parts.

### EXAMPLES

The present invention will be better understood in view of the following non-limiting examples.

Materials and abbreviation

| Materials | Description |
|---|---|
| BL-16 | TDI/polyether, blocked by methyl ethyl ketone oxime |
| | (MEKO), from Lanxess |
| BLM-500 | LF MDI/ polyether, blocked by MEKO, from Lanxess |
| Xylink 311 | Complex of 4,4′-diaminodiphenylmethane with NaCl, |
| | from Suzhou Xiangyuan New Material Co., Jiangsu, |
| | China |
| Duracure C3 | About 44% MDA-NaCl salt dispersed in Dioctyl adipate, |
| | commercially available from Lanxess |
| MDA | 4,4′-diaminodiphenylmethane, from Sigma |
| Bomar ® | a difunctional, aliphatic polyester urethane acrylate from |
| BR-744SD | Dymax, its viscosity at 60° C. is 7000 cP |
| IDA | iso-Decyl Acrylate, from BASF |
| VMOX | Vinyl methyl oxazolidinone (VMOX), from BASF |
| TPO | Photo-initiator, 2,4,6-trimethylbenzoyldiphenylphosphine |
| | oxide (TPO), from IGM |
| ACMO | 4-Acryloylmorpholine, from IGM |
| EBECRYL ® | Urethane based acrylate from Allnex |
| 8413 | |

### Methods

### (1) Hardness

Hardness was Determined in Accordance with ASTM D2240-15 with ASKER DUROMETER (TYPE A).

### (2) Energy Return (Cyclic Tensile Test)

Energy return was determined according to ISO 527-5:2009 with Stable Micro Systems Texture Analyser (TA-HD plus), wherein the parameters used include: Pre-test Speed: 60.0 mm/min; Test Speed (load): 100.2 mm/min; Post-test Speed (unload): 100.2 mm/min; Strain: 50%; Cycles: 6.

The energy return was calculated by the area under loading curve and unloading curve:

Energy Return=(Area Under Unloading Curve)/(Area Under Loading Curve)*100%

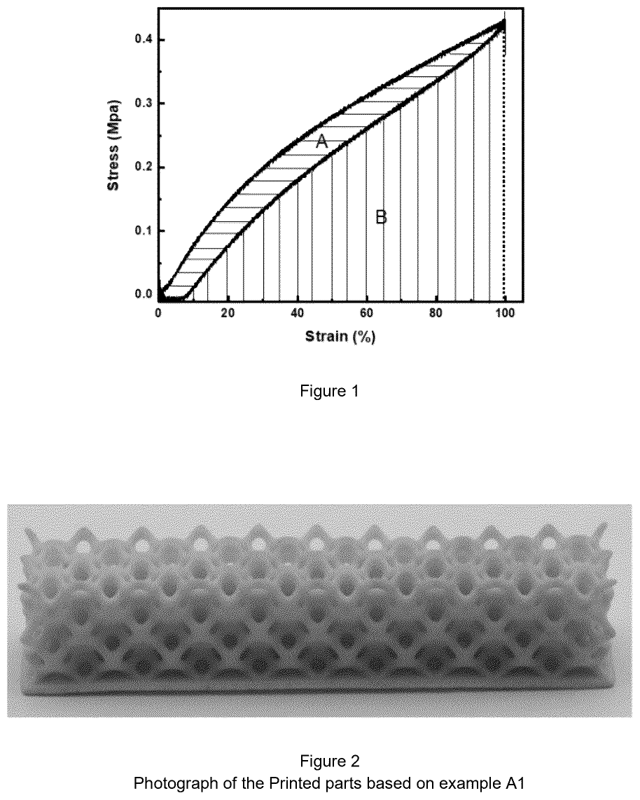

In FIG. 1, Energy Return=B/(A+B)*100%, wherein B represents Area Under Unloading Curve, and A+B represents Area Under Loading Curve.

(3) viscosity

Measured according to DIN EN ISO 3219 at 23° C.

### Examples A1, B1, B2, C₁, B0-1, B0-2, C0

### 1. Preparation of the Curable Compositions

The curable compositions of examples A1, B1, B2, C₁, B0-1, B0-2, C0 were prepared by adding all components in amounts as shown in table 1 into a plastic vial and mixing by speed-mixer at 2000RPM for 10 minutes at 25° C. The amounts in table 1 were provided in parts by weight.

### 2. Preparation of the 3D-Printed Objects

All of the curable compositions were printed by Miicraft DLP 3D respectively and post-treated by UV irradiation and thermal treatment, to obtain 3D-printed objects. The detailed process conditions are listed in Table 2.

The photograph of the 3D-printed object obtained from example A1 is provided in FIG. 2.

### 3. Test

For each curable composition, viscosity of the freshly prepared composition, viscosity of the composition 7 days after its preparation, and viscosity of the composition 14 days after its preparation, were tested.

For each 3D-printed object, hardness (Shore A) and energy return were tested.

Results are listed in table 1.

TABLE 1

| Component | | A1 | B1 | B2 | C1 | B0-1 | B0-2 | C0 |
|---|---|---|---|---|---|---|---|---|
| blocked | BL-16 | 76.9 | 76.7 | 33 | | 88.5 | 38 | |
| diisocyanate | BLM-500 | | | | 40.2 | | | 44.3 |
| blocked | Xylink | 23.1 | | | 9.8 | | | |
| diamine | 311 | | | | | | | |
| | Duracure | | 23.3 | 10 | | | | |
| | C3 | | | | | | | |
| diamine | MDA | | | | | 11.5 | 5 | 5.7 |
| reactive | 744SD | 50 | 30 | 30 | | 30 | 30 | |
| component | 8413 | | | | 30 | | | 30 |
| | IDA | 25 | 35 | 35 | 30 | 35 | 35 | 30 |
| | VMOX | 25 | 35 | 35 | | 35 | 35 | |
| | ACMO | | | | 40 | | | 40 |
| photo-Initiator | TPO | 2 | 2 | 2 | 2 | 2 | 2 | 2 |
| overall | | 202 | 202 | 145 | 152 | 202 | 145 | 152 |
| Viscosity, cP | Fresh | 1662 | 1441 | 521 | 929 | 1278 | 420 | 1320 |
| | After 7 | 1617 | 1404 | 553 | 957 | 1665 | 567 | 1459 |
| | days | | | | | | | |
| | After 14 | 1736 | 1517 | 524 | 938 | 2146 | 714 | 1717 |
| | days | | | | | | | |

| | | | | | | | |
|---|---|---|---|---|---|---|---|
| Hardness (Shore A) | 65 | 74 | 70 | 75 | 75 | 64 | 79 |
| Energy return, (%) | 70 | 44 | 44 | 23 | 41 | 42 | 23 |

TABLE 2
3D-printing stages and parameters of Miicraft DLP 3D

| | |
|---|---|
| stages | Parameters |

| | | |
|---|---|---|
| Printing parameters by | Thickness [μm] | 50 |
| Miicraft | Curing time [s] | 10 |
| | Speed | Advanced |
| | Base layer | 2 |
| | Base Curing Time [s] | 30 |
| | Buffer layer | 2 |
| | Power [%] | 180 |
| Washing | Solvent | Acetone |
| | Time (s) | 30 |
| Post UV-curing | UV irradiation time [min] | 60 |
| | Energy [mW/cm²] | 8 |
| Post thermal-curing | Temperature (° C.) | 130 |
| | Time (h) | 16 |

1.-20. (canceled)

21. A curable composition, which comprises:
(A) at least one unreactive blocked diisocyanate;
(B) at least one unreactive blocked diamine;
(C) at least one reactive component; and
(D) at least one photo-initiator,
wherein component (B) is formed by blocking diamine with a ligand.

22. The curable composition according to claim 21, the diisocyanate for forming component (A) comprises diisocyanate monomers and/or diisocyanate prepolymers,
wherein
the diisocyanate monomers are selected from the group consisting of aliphatic diisocyanate, araliphatic diisocyanate, cycloaliphatic diisocyanate, aromatic diisocyanate, and the combination thereof;
the diisocyanate prepolymers are prepolymers having two free isocyanate groups, obtained from the reaction of diisocyanate monomers with polyester diols, polyether diols, polycarbonate diols, or diamines.

23. The curable composition according to claim 21, wherein the diamine for forming component (B) is selected from the group consisting of aliphatic diamine, cycloaliphatic diamine, aromatic diamine, aliphatic-aromatic diamine, cycloaliphatic-aromatic diamine, aliphatic-cycloaliphatic diamine and combinations thereof.

24. The curable composition according to claim 21, wherein reactive component (C) contains at least one radiation-curable functional group.

25. The curable composition according to claim 21, wherein the photo-initiator is a free radical photo-initiator and/or an ionic photo-initiator.

26. The curable composition according to claim 21, wherein the amount of component (A) is in the range from 0.1 to 85% by weight based on the total weight of the composition.

27. The curable composition according to claim 21, wherein the amount of component (B) is in the range from 0.1 to 85% by weight based on the total weight of the composition.

28. The curable composition according to claim 21, wherein the amount of component (C) is in the range from 10 to 99% by weight based on the total weight of the composition.

29. The curable composition according to claim 21, wherein the amount of component (D) is in the range from 0.1 to 10% by weight based on the total weight of the composition.

30. The curable composition according to claim 21, wherein after deblocking component (A) and component (B), the molar ratio of isocyanate group to amino group in the composition is in a range from 1.3 to 0.7.

31. The curable composition according to claim 21, wherein the ligand is selected from monodentate ligands; bidentate ligands; and polydentate ligands.

32. The curable composition according to claim 21, which further comprises component (E) an auxiliary agent.

33. The curable composition according to claim 21, wherein the change of the viscosity of the curable composition measured according to DIN EN ISO 3219 at 23° C. from being freshly prepared to being stored for 7 days is less than 10%.

34. The curable composition according to claim 21, wherein the change of the viscosity of the curable composition measured according to DIN EN ISO 3219 at 23° C. from being freshly prepared to being stored for 14 days is less than 10%.

35. A process of forming a 3D-printed object, comprising using the curable composition according to claim 21.

36. The process according to claim 35, wherein the process comprises the steps of:
(i) applying the composition in form of a layer, and curing the applied composition layer by layer by radiation to form an intermediate 3D-printed object;
(ii) curing the whole intermediate 3D-printed object by radiation to form a cured 3D-printed object; and
(iii) thermally curing the whole cured 3D-printed object to form a final 3D-printed object.

37. The process according to claim 36, wherein stereolithography, photopolymer jetting, digital light processing, or LCD technology is used in step (i) to form the intermediate 3D-printed object.

38. The process according to claim 36, wherein the radiation is UV radiation.

39. A 3D-printed object obtained by the process according to claim 35.

40. The 3D-printed object according to claim 39, wherein the 3D-printed object comprises sole, outerwear, cloth, footwear, toy, mat, tire, hose, gloves, seals, medical appliances, and dental parts.
